(19) United States
(12) Patent Application Publication
(10) Pub. No.: US 2010/0067488 A1
(43) Pub. Date: Mar. 18, 2010

(54) WIRELESS TERMINAL AND HANDOVER METHOD OF WIRELESS TERMINAL

(75) Inventor: Toshiyuki Sashihara, Tokyo (JP)

Correspondence Address: Mr. Jackson Chen, 6535 N. STATE HWY 161, IRVING, TX, 75039, US

(73) Assignee: NEC CORPORATION, Tokyo (JP)

(21) Appl. No.: 12/527,742

(22) PCT Filed: Dec. 10, 2007
(86) PCT No.: PCT/JP2007/073780

§ 371 Date: Aug. 19, 2009

(30) Foreign Application Priority Data
Feb. 19, 2007 (JP) 2007-037468

(51) Int. Cl. H04W 36/00

(52) U.S. Cl. 370/331

(57) ABSTRACT

A wireless terminal includes a data transmitting/receiving function and a handover control section. The handover control section scans channels to detect the existence or non-existence of the handover destination candidate on all available wireless channels. The handover control section acquires the handover destination candidate, by scanning the existence or non-existence of the handover destination in advance before handover execution. The verification scan is carried out to check whether or not the candidate is in a communicable area with the terminal. Then, based on the execution result of the verification scan, it performs a handover.

### TECHNICAL FIELD

The present invention relates to a wireless terminal and a handover method of a wireless terminal.

### BACKGROUND ART

In association with the advancement of information communication technology, a wireless LAN has become widely popular. As a technique for properly attaining mobile communication in which the wireless LAN is used, a technique referred to as a handover is known. Japanese Patent Application Publication (JP-P2002-016958A: conventional example 1) describes a technique that uses spreading code corresponding to a base station selected from a base station candidate list, tries the reception of a pilot signal from the base station, and then determines whether or not it is suitable as the base station of a handover destination. Japanese Patent Application Publication (JP-P2004-207922A: conventional example 2) describes a technique in which as a handover processing method used in a wireless LAN system, a wireless terminal apparatus stores data of a wireless base station in an access point (AP) connection candidate list, as a result of a scanning process. Japanese Patent Application Publication (JP-P2005-175932A) describes a technique with regard to a wireless LAN handover process. Japanese Patent Application Publication (JP-P2005-184160A) describes a technique with regard to a handover solution method.

When carrying out the handover, the wireless LAN terminal uses data of access points collected in advance to select an optimal access point, and moves to a channel used by the access point, and then transmits Authentication Request and Re-association Request frames. The collection of the data of the access points is carried out by receiving a Beacon frame or transmitting a Probe Request frame through a usable channel and collecting a Probe Response frame that is a response to the frame. However, when the data of the access points are collected over usable all channels, it takes a time to switch wireless channels for each channel or collect the Beacon frame or the Probe Response frame. For this reason, this operation is expensive in temporal and power costs. Thus, this operation is not frequently carried out but typically carried out in the interval of several seconds to several tens of seconds. The data of the newest access point is data before a current time by one time period, in the oldest case.

When the terminal is moving and the data of the access point is old, there is a possibility that the access point determined to be optimal cannot be already connected. In that case, it is necessary to collect the data of the access point over all the channels again and to then select the optimal access point.

When data are collected by use of a channel differing from a channel of the access point currently being used during a process of collecting the data of this access points, it is impossible to communicate with the access point currently being used. Thus, when this data collection is carried out during speech/audio communication in VoIP, there is a case that the data collection appears as a speech/audio break that can be recognized by a user.

### DISCLOSURE OF INVENTION

An object of the present invention is to reduce a case that a handover process is failed because an incommunicable access point is selected as a handover candidate, when the handover is carried out.

In the present invention, a wireless terminal contains a data transmitting/receiving function and a handover controller. The handover control section scans all usable wireless channels to detect the presence or absence of the handover destination. Since scanning the channels to detect the presence or absence of the handover destination in advance prior to an handover execution, the handover control section obtains the handover destination candidate and executes a verification scan in order to check whether or not the candidate is located within the communicable area with the terminal, and then performs the handover on the candidate in accordance with the execution result of the verification scan.

The present invention can reduce failure of the handover because the incommunicable access point is selected as the handover candidate, when the handover is carried out.

### BRIEF DESCRIPTION OF THE DRAWINGS

The above-mentioned objects, effects and features of the present invention will be evident from the descriptions of the embodiments in conjunction with the attached drawings.

FIG. 1 is a conceptual view showing a concept of a wireless LAN network in which a handover is carried out;

FIG. 2 is a block diagram showing a configuration of a VoIP terminal 7;

FIG. 3 is a block diagram showing a configuration of software sections stored in a ROM 12;

FIG. 4 is a sequence diagram showing the operations of the exemplary embodiment;

FIG. 5A is a flowchart describing a determination of a necessity of the handover and a procedure of a handover process;

FIG. 5B is a flowchart describing a determination of a necessity of the handover and a procedure of a handover process;

FIG. 5C is a flowchart describing a determination of a necessity of the handover and a procedure of a handover process;

FIG. 6 is a flowchart showing the operation of an all-channels scan;

FIG. 7 is a flowchart showing the operations of a scanning process;

FIG. 8 is a sequence diagram showing an operation for deciding a time of non-communication;

FIG. 9 is a flowchart showing the operations of a background all-channels scan;

FIG. 10A is a flowchart showing the operations of a second exemplary embodiment;

FIG. 10B is a flowchart showing the operations of a second exemplary embodiment;

FIG. 11A is a sequence diagram showing the operations when the verification scan is not carried out; and

FIG. 11B is a sequence diagram showing the operations when the verification scan is not carried out.

### BEST MODE FOR CARRYING OUT THE INVENTION

Hereinafter, a wireless LAN network according to exemplary embodiments of the present invention will be described in detail with reference to the attached drawings. However, the exemplary embodiments do not limit the technical range of the present invention.

### First Exemplary Embodiment

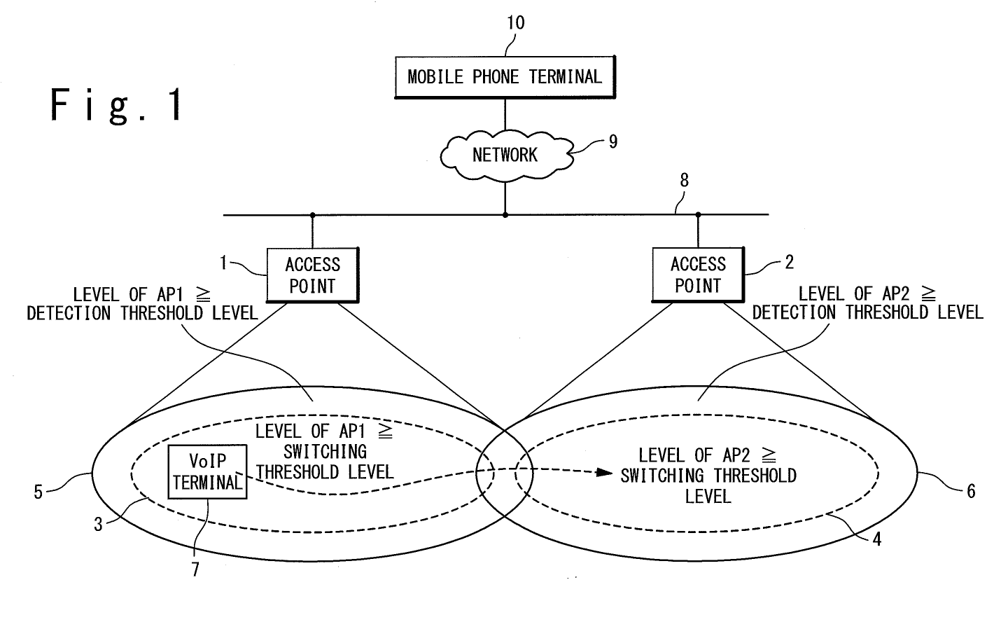

FIG. 1 is a diagram showing the concept of a wireless LAN network in which handover is carried out. The wireless LAN network includes a first access point 1 (AP1), a second access point 2 (AP2), a first area 3, a second area 4, a third area 5, a fourth area 6, the VoIP terminal 7, a wired network 8, a wide area network 9 and a mobile phone terminal 10.

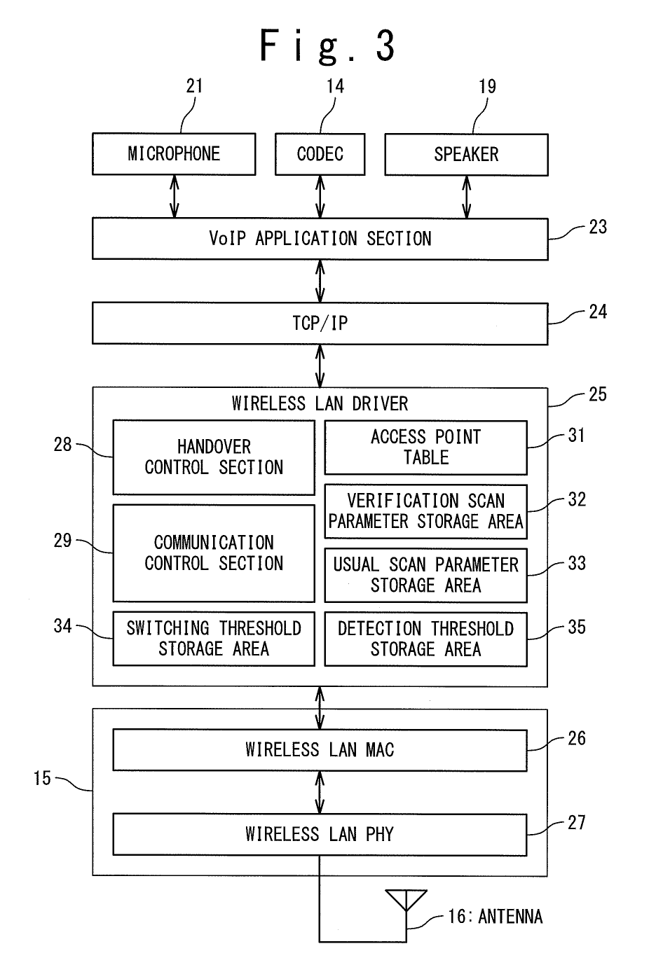

The first access point 1 and the second access point 2 are access points based on the specifications of IEEE 802.11. The first area 3 is a area in which the reception electric field intensity of the first access point 1 is equal to or greater than a switching threshold level (the switching threshold level is described in FIG. 3). The second area 4 is an area in which the reception electric field intensity of the second access point 2 is equal to or greater than a switching threshold level. The third area 5 is an area in which the reception electric field intensity of the first access point 1 is equal to or greater than a detection threshold level (the detection threshold level is described in FIG. 3). The fourth area 6 is an area in which the reception electric field intensity of the second access point 2 is equal to or greater than a detection threshold level.

A VoIP terminal 7 is a terminal that has a function for performing a VoIP communication by using a wireless LAN. In other words, a wireless LAN apparatus is incorporated in the VoIP terminal 7, and the wireless LAN apparatus has a function for performing a handover in this exemplary embodiment.

The wired network 8 connects the first access point 1 and the second access point 2. For example, this is represented by a network such as Ethernet (registered trademark). The wide area network 9 is a network through which the mobile phone terminal 10 and the wired network 8 are connected, and the Internet or the like corresponds to this. The mobile phone terminal 10 is a terminal of the communication destination of the VoIP terminal 7. In this exemplary embodiment, the mobile phone terminal 10 is not always required to be the VoIP telephone.

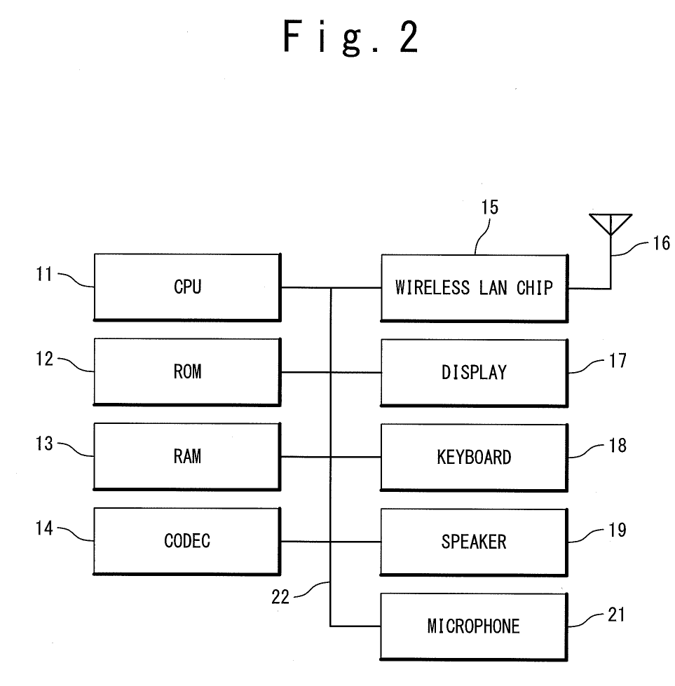

The VoIP terminal 7 will be described below. FIG. 2 is a block diagram showing a configuration of the VoIP terminal 7. The VoIP terminal 7 contains a CPU (Central Processing Unit) 11, a ROM (Read Only Memory) 12, a RAM (Random Access Memory) 13, a CODEC (coder/decoder) 14, a wireless LAN (Local Area Network) chip 15, a display 17, a keyboard 18, a speaker 19 and a microphone 21. They are connected through a bus 22. Also, an antenna 16 is connected to the wireless LAN chip 15.

The CPU 11 executes software programs stored in the ROM and the RAM. The ROM 12 is a nonvolatile memory dedicated to read. The ROM 12 stores software programs required to drive the VoIP terminal 7 and OS. The RAM 13 is a volatile memory and used as a area to temporally hold data. It should be noted that the ROM 12 or the RAM 13 may be a nonvolatile memory such as a flash memory and the like in which the data can be erased.

The CODEC 14 converts sound data supplied from the microphone 21 into digital data with a format such as ITU-T G.711, or reversely converts the digital data with the format such as G.711 into the digital data to be reproduced in the speaker 19. The wireless LAN chip 15 is a chip for processing a wireless LAN protocol defined in IEEE 802.11. The antenna 16 is an apparatus for transmitting a signal sent from the wireless LAN chip 15 as radio wave and simultaneously receiving radio waves from the first access point 1 and the second access point 2 or another VoIP terminal.

The display 17 is a display unit that uses a liquid crystal or the like. The keyboard 18 is a keyboard to input a telephone number and the like. When inputting the speech/audio data converted by the CODEC 14, the speaker 19 outputs as a speech/audio data. The microphone 21 converts the sound into a digital signal.

The software programs contained by the VoIP terminal 7 will be described below. In the following exemplary embodiment, the software programs except for an OS is preferred to be stored in the ROM 12. FIG. 3 is a block diagram showing a software configuration in the ROM 12. The software configuration in the ROM 12 of the VoIP terminal 7 includes a VoIP application section 23, a TCP/IP processing section 24, a wireless LAN driver 25, a wireless LAN MAC 26 and a wireless LAN PHY 27.

The VoIP application section 23 performs a control such that a speech/audio data received from the microphone 21 is converted into a coded data with the format of the G.711 definition by the CODEC 14 and the coded data is stored into a payload section of an RTP packet, and then the packet is transferred to the TCP/IP processing section 24. Also, the VoIP application section 23 performs a control such that the coded data with the G.711 format is extracted from the payload section of an RTP packet received from the TCP/IP processing section 24, and the extracted data is converted into a speech/audio data with the format that can be reproduced by the speaker 19 by means of the CODEC 14, and the speech/audio data is transferred to the speaker 19 to reproduce the received speech/audio data.

The TCP/IP processing section 24 is a section for processing the TCP/IP protocol that is defined in RFC791 and RFC793 issued from IETF. The wireless LAN driver 25 contains software programs for controlling the wireless LAN chip 15. The wireless LAN MAC 26 and the wireless LAN PHY 27 are stored in the wireless LAN chip 15, and the wireless LAN MAC 26 is a section for processing the MAC protocol defined in IEEE 802.11. Also, the wireless LAN PHY 27 is a section for processing the PHY protocol of the same specification.

The wireless LAN driver 25 includes a handover control section 28, a communication control section 29, an access point table 31, a verification scan parameter storage area 32, a usual scan parameter storage area 33, a switching threshold storage area 34 and a detection threshold storage area 35. The handover control section 28 collects the data of access points existing around the VoIP terminal, determines the necessity of handover, selects a handover destination, and executes a handover process. The communication control section 29 carries out a control necessary for communication other than the control carried out by the handover control section 28. The access point table 31 is an area where the data of access points obtained through a scanning operation of the VoIP terminal 7 are stored, and the data of access points as the candidates of the handover destination are stored here.

The switching threshold storage area 34 stores a switching threshold. The detection threshold storage area 35 stores a detection threshold. The detection threshold is a minimum level of the reception electric field intensity at which the VoIP terminal 7 can communicate with the access point. On the other hand, the switching threshold is a level slightly higher than the detection threshold. Specifically, when the VoIP terminal 7 is moving, a time period which is necessary to reduce the reception electric field intensity of the access point on communication from the switching threshold to the detection threshold, becomes longer than a time period which is necessary to perform the verification scan and the background all-channels scan, which will be described below. The switching threshold depends on the moving speed supported by the VoIP terminal 7 as the specification, and when it should correspond to the faster movement, the switching threshold is required to be higher than the detection threshold.

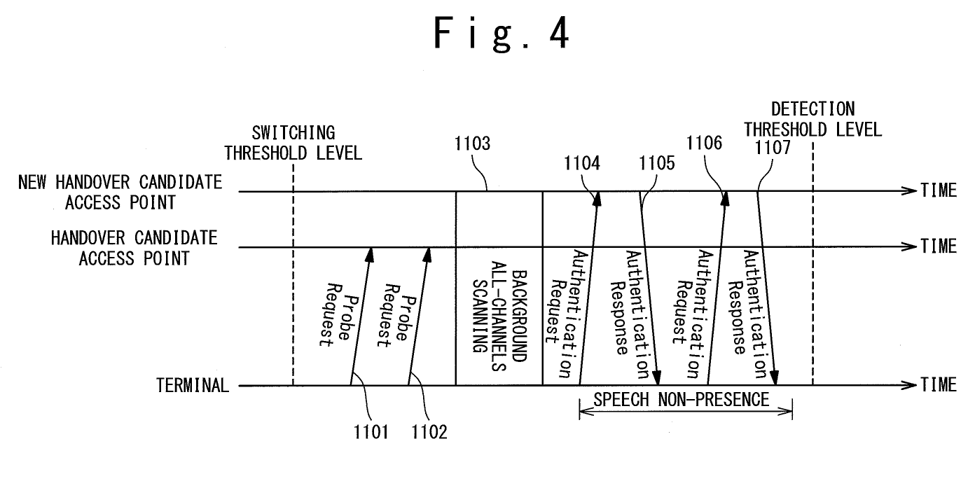

The operation of the first exemplary embodiment will be described below. FIG. 4 is a sequence diagram showing the operation of the wireless LAN network in the first exemplary embodiment. At first, when the verification scan is carried out, probe request frames 1101, 1102 are transmitted. In this case, since the terminal is located outside the communicable area of the access point of a handover candidate, there is no response by using a probe response frame. Parameters Min-Channel-Time and Max-Channel-Time that are stored in the parameter storage area for the verification scan are maximum and can take the greater one of “a time period from a time when the VoIP terminal receives a speech/audio frame from the access point to a time period when the speech/audio frame is transmitted to the access point” (a first time period L1 which will be described later) and “a time period from a time when the VoIP terminal transmits the speech/audio frame to the access point to a time when the speech/audio frame is received from the access point” (a second time period L2 which will be described later) (the detail with regard to the first time period L1 and the second time period L2 will be described later). However, when they are excessively great, the time period necessary for the verification scan becomes long. For this reason, in this exemplary embodiment, they are assumed to be several ms, and both are assumed to have the same value. Thus, the time required to determine that the access point of the handover candidate does not exist is ten-odd ms at the longest.

In a time period during which this verification scan is carried out, the terminal is located in the communicable area of the access point in the communication state at present, and this is carried out such that the transmission/reception of the data of the terminal is not obstructed. Thus, in this time period, the speech/audio signal non-presence does not occur. After that, the whole scan (hereinafter, to be referred to as a “background all-channels scan”) is carried out while the data transmission/reception is continued (1103), and the candidate of the handover destination is newly found out.

When the background all-channels scan is ended, exchange of authentication request/response messages (1104, 1105) and Association Request/Response messages (1106, 1107) with a candidate of a new handover destination is carried out. Thus, the handover is completed to the access point of the new handover destination candidate.

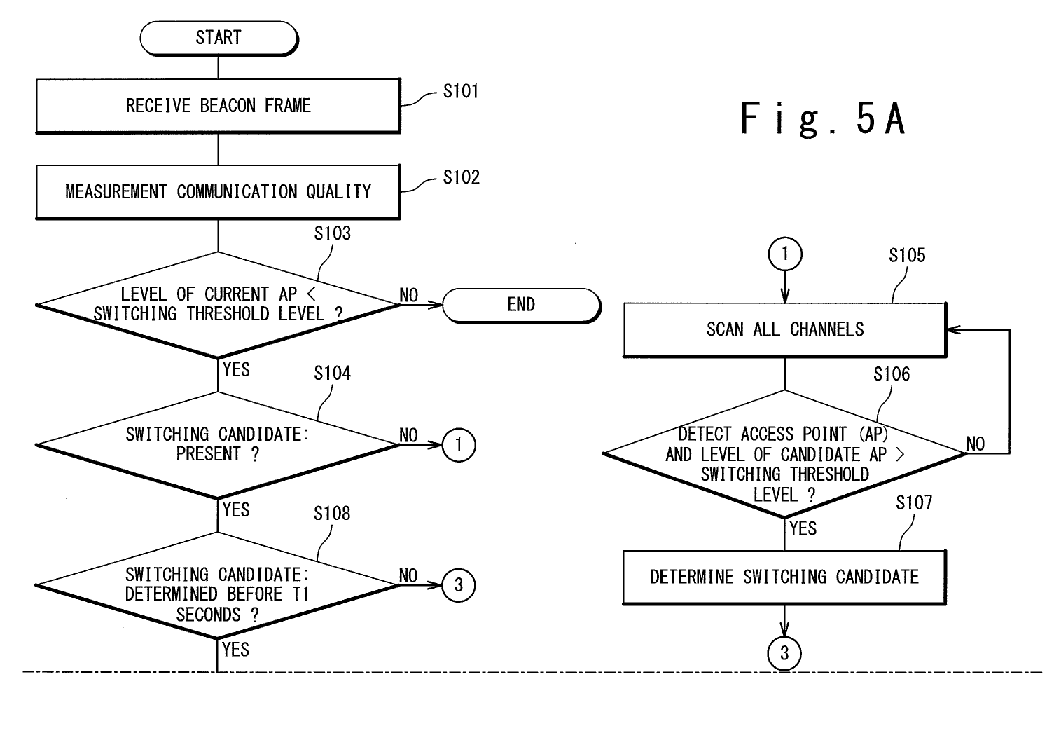

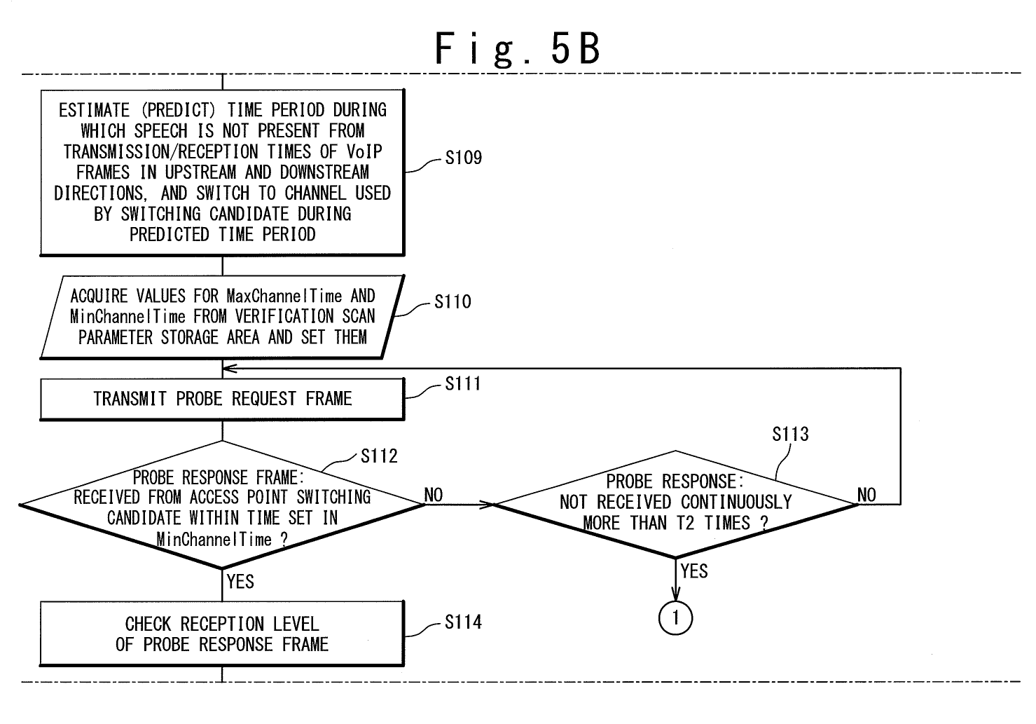

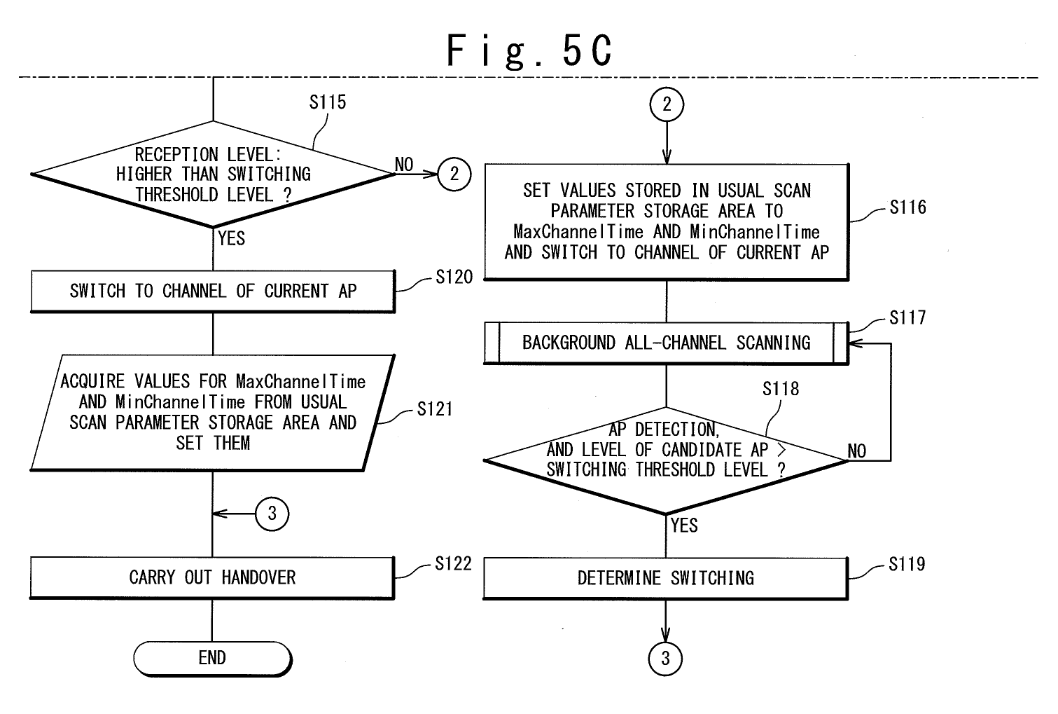

The foregoing operation will be described below in detail by using flowcharts. FIGS. 5A to 5C are the flowcharts showing determination of necessity of handover in the handover control section 28, and a procedure of the handover process. The operations shown in FIGS. 5A to 5C are periodically carried out in the VoIP terminal 7. It should be noted that in the exemplary embodiment, a case where a cell design is carried out in advance and there is not an access point that provides the service by using a same channel in a same area.

At a step S101, the wireless LAN MAC 26 receives a beacon frame. The reception of the beacon frame is notified to the wireless LAN driver 25 with an interruption. At a step S102, when receiving the interruption of the beacon frame reception, the wireless LAN driver 25 obtains the reception electric field intensity on the reception of the beacon frame. At a step S103, the wireless LAN driver 25 checks whether or not the obtained reception electric field intensity is smaller than the switching threshold. If the reception electric field intensity is equal to or greater than the switching threshold, the handover process is ended.

In case of the reception electric field intensity smaller than the switching threshold, the control flow proceeds to a step S104. At the step S104, the wireless LAN driver 25 refers to the access point table 31 to check the presence or absence of the access point as any handover destination candidate. Usually, even if the reception electric field intensity of the access point in the current communication state is equal to or greater than the switching threshold, the VoIP terminal 7 always holds the access point as the handover destination candidate through the all-channels periodical scan. At this time, when there is no candidate, the control flow proceeds to a step S105, and the all-channels scan is carried out.

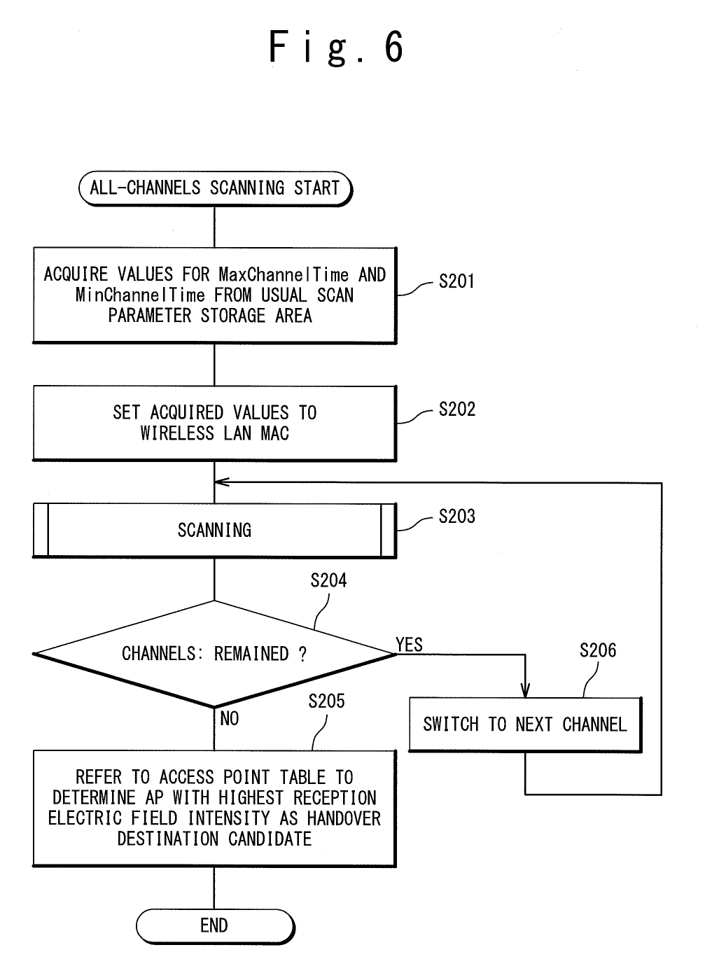

Here, the operation for the all-channels scan will be described. FIG. 6 is a flowchart showing the operation of the all-channels scan. At a step S201, the values to be set for each of Max-Channel-Time and Min-Channel-Time is obtained from the usual scan parameter storage area 33. Next, at a step S202, the obtained Max-Channel-Time and Min-Channel-Time are set to the wireless LAN MAC 26. At a step S203, when those values are set, a scanning process is executed on the wireless channel used by the current access point AP. The detail of the scanning process at the step S203 will be described later.

At a step S204, when the scanning operation is finished, the existence of unscanned channel among usable channels is next checked. If no unscanned channel is left, the control flow proceeds to a step S205, and if there remains any channel to be switched, the control flow proceeds to a step S206. At the step S205, the data recorded in the access point table 31 are referred, and the access point having the highest reception electric field intensity is selected as the handover destination candidate, and the all-channels scanning process is then ended. At the step S206, the channel is switched to a next channel of the non-checked channels, and the control flow returns to the step S203 at the newly switched channel. Again, the scanning process is executed.

The whole scan is an operation that requires the time of the Min-Channel-Time at the minimum and the time of the Max-Channel-Time at the maximum. The values set for the Min-Channel-Time and the Max-Channel-Time are not especially determined. However, there is an intention to collect the data of as many access points as possible. Thus, the respective values between several tens of ms and several hundreds of ms are usually set. For this reason, there is a case that one second or more is required to scan all of the channels.

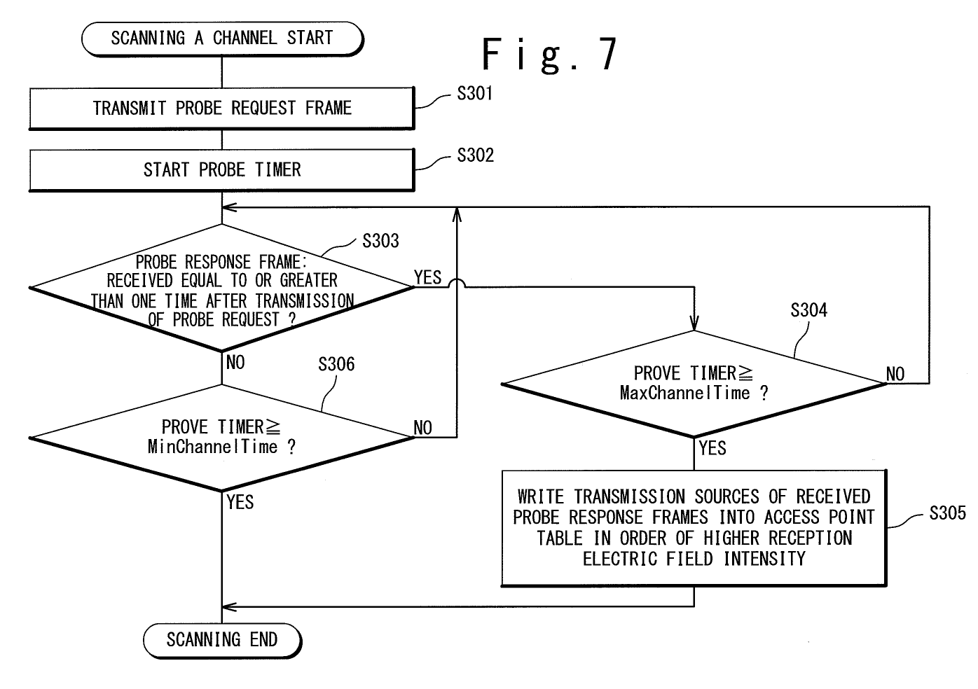

Here, the scanning process at the step S203 will be described. FIG. 7 is a flowchart showing the operations of the scanning process on a channel. At a step S301, a Probe Request frame is transmitted on the specified wireless channel. At a step S302, simultaneously with the transmission of the Probe Request frame, a Probe Timer is started. At a step S303, whether or not the Probe Response frame is received is checked. When any frame is not still received in this scanning course, the control flow proceeds to a step S306. At the step S306, whether or not the Probe Timer is equal to or greater than the Min-Channel-Time is checked. If in this scanning process, the Min-Channel-Time elapses without reception of any frame of the Probe Response, it is determined that the access point does not exist in this channel, and the scanning process on this channel is ended. At the step S306, if the Probe Timer is less than the Min-Channel-Time, the control flow returns to the step S303, and it is waited that the Probe Response frame is sent until the elapse of the Min-Channel-Time.

At the step S303, when the Probe Response is received even one time after the transmission of the Probe Request, the control flow proceeds to the step S304. When the Probe Response is received even one time, whether or not the Probe Timer is equal to or greater than the Max-Channel-Time is checked at the step S304. When the Probe Timer is not equal to or greater than the Max-Channel-Time, the control flow returns to the step S303, and the Probe Response frame is collected until the elapse of the time of the Max-Channel-Time. In case of the elapse of the Max-Channel-Time or more, the control flow proceeds to the step S305. At the step S305, as for the Probe Response frame received in this scanning process, the transmission source of the Probe Response frame and the reception electric field intensity are written into the access point table 31. As mentioned above, the scanning process on a channel is ended.

The operation in the flowchart shown in FIGS. 5A to 5C will be described again. With reference to FIGS. 5A to 5C, after the completion of the whole scan of the step S105, the control flow proceeds to a step S106. At the step S106, the reception electric field intensity of the access point selected as the handover destination candidate as the result of the whole scan is compared with the switching threshold by referring to the access point table 31. As the result of the comparison, if the reception electric field intensity of the access point of the candidate is greater than the switching threshold, the control flow proceeds to a step S107. At the step S107, the access point is determined as the access point of the handover destination candidate which is actually communicable. After that, the control flow proceeds to a step S122, and the handover is carried out. As the result of the comparison of the step S106, if the reception electric field intensity of the access point of the candidate is equal to or smaller than the switching threshold, the process returns to the all-channels scanning process. Then, the all-channels scan is repeated until the occurrence of the access point whose reception electric field intensity is higher than the switching threshold.

A case of the existence of the handover destination candidate at the step S104 will be described below. In case of the existence of the handover destination candidate, at a step S108, in order to check a time after acquisition of the data of the handover destination candidate, whether or not it is acquired prior to a threshold T1 second or more is determined.

As the result of the determination, if it is determined in the threshold T1 second or less, the data is regarded to be new, and the probability of the data is regarded to be high. Then, without any execution of the verification scan, the control flow proceeds to the step S122, and the handover process is executed in its original state. If the data of the handover destination candidate is old data after the elapse of T1 second or more, the control flow proceeds to a step S109, and the verification scan is carried out. At the step S109, the time of non-communication is determined from the transmission/reception time of the VoIP frame in the up and down directions. Then, the non-communication time is selected, thereby switching to the channel used by the access point of the handover destination candidate.

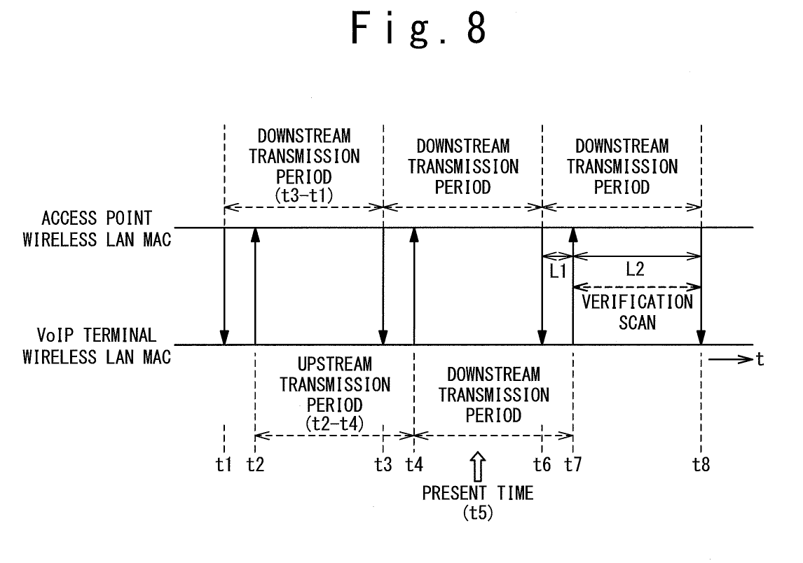

Here, the operation for determining the time of the non-communication will be described. FIG. 8 is a sequence diagram showing the operation for determining the time of the non-communication. In this exemplary embodiment, the time of the non-communication is determined by using the periodicity of the VoIP frame. At first, a current time is defined as t5. Also, it is supposed that the VoIP terminal 7 receives the VoIP frames from the access point at a time t1 and a time t3. Moreover, it is supposed that at a time t2 and a time t4, the VoIP terminal 7 transmits frames in the upstream direction.

With reference to FIG. 8, a time when the VoIP terminal will next receive a frame from the access point can be predicted as follows:

Time t6=Time t3+(Time t3−Time t1)

Also, a time t8 when a frame will be received from the access point after the foregoing frame can be similarly predicted as follows:

Time t8=Time t6+(Time t3−Time t1)

Also, a time when the VoIP terminal itself will transmit a frame in the upstream direction can be predicted as follows:

Time t7=Time t4+(Time t4−Time t2)

As the time period when the verification scan is carried out, there are two of a time period (hereinafter, to be referred to as a first time period L1) from the time when the VoIP terminal receives a speech/audio frame from the access point to the time when a speech/audio frame is transmitted to the access point; and a time period (hereinafter, to be referred to as the second time period L2) from the time when the VoIP terminal transmits a speech/audio frame to the access point to the time when a speech/audio frame is received from the access point. In this case, the first time period L1 and the second time period L2 can be respectively calculated as follows;

First Period L1=Time t7−Time t6

Second Period L2=Time t8−Time t7

Next, which of the first time period L1 or the second time period L2 is longer is checked. When the first time period L1 is longer, the verification scan is carried out just after the VoIP frame is received at the time t6. When the second time period L2 is longer, the verification scan is carried out just after the frame of the up direction is transmitted. The time period of the non-communication is determined as mentioned above.

Again, the flowchart of FIGS. 5A to 5C will be described. At the step S109, the channel is switched to the channel used by the handover destination candidate. After that, at a step S110, the values of the Max-Channel-Time and the Min-Channel-Time are obtained from the verification scan parameter storage area 32 and then set respective. The verification scan intends to check whether or not there is a target access point. For this purpose, several ms are set as the values of the Max-Channel-Time and the Min-Channel-Time. It is assumed in this exemplary embodiment that the access point which provides service by using a same channel in a same area does not almost exist. For this reason, the access point that responds to the Probe Response is only the access point which is intended to be checked by the VoIP terminal.

At a step S111, the Probe Request frame is transmitted. When the Probe Request frame is transmitted, whether or not the Probe Response frame as the response to the Probe Request frame is received from the access point of the handover destination candidate within the time of the Min-Channel-Time is checked at a step S112. As the result of the check, if it is not received, the control flow proceeds to a step S113.

At the step S113, whether or not the response to the Probe Request frame has not been received continuously more than the number of times indicated by a threshold T2 is checked. If the response to the Probe Request has not been received continuously more than the number of times indicated by the threshold T2 from the access point of the handover destination candidate, this case is regarded as the non-existence of the access point of the handover destination candidate. Then, the control flow proceeds to the step S105, and the all-channels scan is carried out. As the result of the check, if it does not reach the number of times indicated by the threshold T2, the control flow returns to the step S111, and the Probe Request frame is again transmitted.

When a value of the threshold T2 is excessively great, the time necessary for the verification scan becomes long. Thus, at the longest, the threshold T2=about 2 is set. At the step S112, when the Probe Response frame is received from the access point of the handover destination candidate within the Min-Channel-Time, the control flow proceeds to a step S114. Then, the reception electric field intensity of the Probe Response frame is checked. At a step S115, the reception electric field intensity and the switching threshold are compared. As the result of the comparison, when the reception electric field intensity of the Probe Response frame is smaller than the switching threshold, the control flow proceeds to a step S116. In this case, the terminal is regarded to have moved outside the communicable area of the access point of the handover destination candidate. Then, the access point of the handover destination candidate is again searched.

However, in order not to obstruct the current communication, the all-channels scan is preferably carried out in the background, and the search is again carried out. For this reason, at the step S116, the Max-Channel-Time and the Min-Channel-Time are returned to the parameters stored in the usual scan parameter storage area, and the switching to the channel of the access point in the current communication state is carried out. At a step S117, the background all-channels scan is carried out in which the all-channels scan is carried out between the communications.

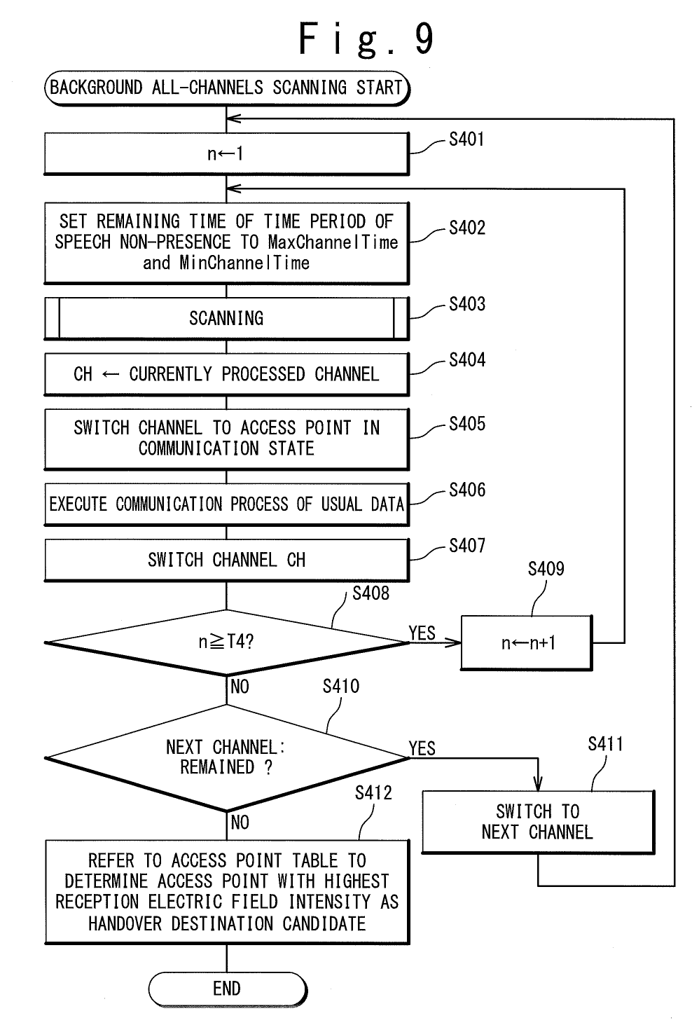

Here, the operation of the background all-channels scan will be described. FIG. 9 is a flowchart showing the operation of the background all-channels scan. With reference to FIG. 9, at a step S401, “1” is substituted into a variable n for holding the number of times of scan. At a step S402, the remaining time of a non-communication zone is set for the Max-Channel-Time and the Min-Channel-Time. As mentioned above, the time when a non-communication zone is ended is known in advance. Thus, the remaining time is obtained by subtracting the current time from the time when the non-communication zone is ended.

At a step S403, the scanning process is executed. This scanning process is similar to the process of the step S105. The timing when the scanning process is ended is the timing when the VoIP terminal transmits or receives a data. At a step S404, in order to hold the scanned channel, the current channel is substituted into a variable CH.

At a step S405, when the current channel is set to the variable CH, the channel is switched to a channel used by the access point with which this terminal communicates. When the channel switching is ended, a process for transmitting or receiving the data is executed at a step S406. When the process for transmitting or receiving the data is ended, the variable CH is referred to at a step S407, so that the channel is switched to the previously scanned channel.

At a step S408, the number of times of scan of the same channel is checked. As the result of the check, if the number of times of actual scan is less than the number of times indicated as a certain threshold T4, the control flow proceeds to a step S409. At the step S409, “1” is added to the variable n, and the control flow is returned to the step S402. On the other hand, if the number of times of scan is already more than the number of times indicated as the threshold T4, the control flow proceeds to a step S410.

At the step S410, whether or not there remains any non-checked channel to be switched to next switching is checked. As a result, if the non-checked channel remains, the control flow proceeds to S411. At the step S411, the check channel is switched to a next-usable channel that is not still checked, and the control flow is returned to the step S401. If the non-checked channel does not remain, the control flow proceeds to the step S412. At the step S412, the access point table 31 is referred, and the access point having the greatest reception electric field intensity is determined as the handover destination candidate.

In the background all-channels scan, when the threshold T4 is increased, the surer scan can be carried out. However, when it is excessively great, the time necessary for the background all-channels scan becomes long. Thus, it is reasonable that “1” to “2” is set for the threshold T4.

Again, the flowchart of FIGS. 5A to 5C will be described. After the performance of the background all-channels scan at the step S117, the control flow proceeds to a step S118. At the step S118, the access point table 31 is referred, and the reception electric field intensity of the access point serving as the handover destination candidate is compared with the switching threshold. As the result of the comparison, if the reception electric field intensity of the handover destination candidate is smaller than the switching threshold, the background all-channels scan is again carried out, and this is repeated until the occurrence of the suitable access point. As the result of the comparison, if the reception electric field intensity of the handover destination candidate is greater than the switching threshold, the control flow proceeds to a step S119. At the step S119, the access point of the handover destination candidate is determined as a formal handover destination. Then, the control flow proceeds to the step S122, and the handover is carried out. As the result of the process of the step S115, if the reception electric field intensity of the Probe Response frame is equal to or greater than the switching threshold, the control flow proceeds to a step S120. At the step S120, the access point serving as the handover destination candidate is regarded as the access point destination on which the handover can be carried out even at this time. In this case, the handover destination candidate is not again searched. The VoIP terminal 7 is switched to a channel used by the access point in the current communication state.

At a step S121, values to be set for the Min-Channel-Time and the Max-Channel-Time are acquired from the usual scan parameter storage area 33, and set respectively. Then, at the step S122, the handover is carried out on the access point of the handover destination candidate.

It should be noted that the verification scan in this exemplary embodiment will be described by using a scheme that the Min-Channel-Time and the Max-Channel-Time are reduced to several ms, in order to perform the verification scan within an area based on the existing IEEE 802.11. When a verification scan is carried out using a Probe Request with an access point address as a destination address, which is out of IEEE 802.11 specification, an Ack (Acknowledgement) frame can be received only after SIFS (Short Interframe Space) interval because of the response for unicast frame. In this case, it is possible to perform the verification scan faster and surer.

### Second Exemplary Embodiment

The second exemplary embodiment of the present invention will be described below. It should be noted that the configuration of the VoIP terminal 7 in the second exemplary embodiment is similar to the above-mentioned first exemplary embodiment. Thus, the same description is omitted. The verification scan is useful even in an area in which the reception electric field intensity of the access point in the communication state at present is equal to or greater than the switching threshold.

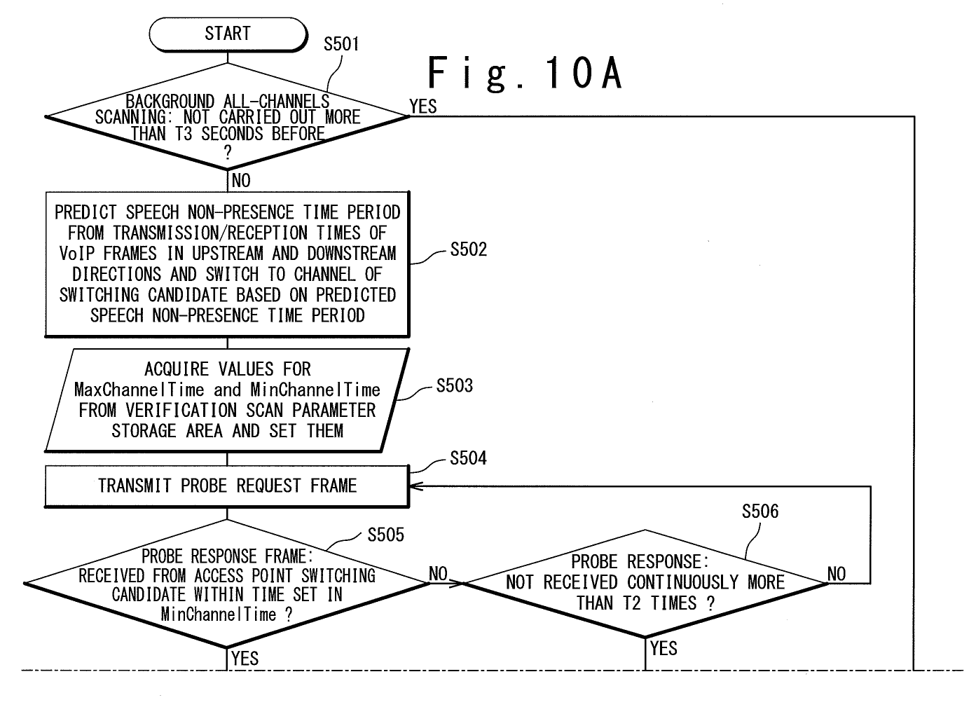

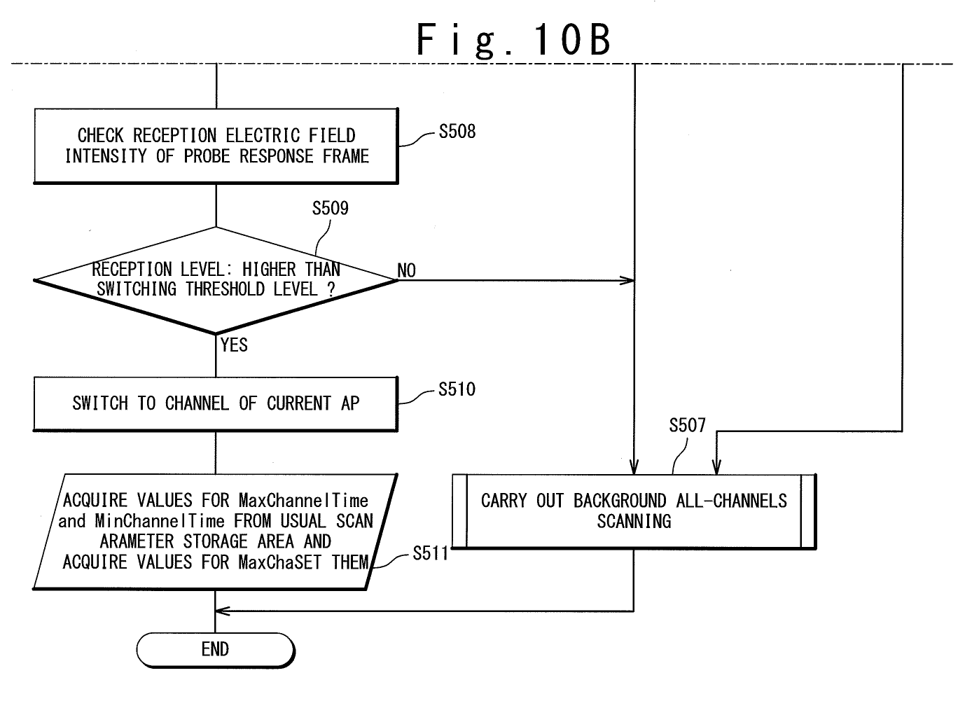

FIG. 10A and FIG. 10B are a flowchart showing an operation of the second exemplary embodiment. The second exemplary embodiment is assumed such that an access point as the handover destination candidate is held through a previous all-channels scan.

At a step S501, the determination of whether or not the background all-channels scan has been carried out for more than seconds indicated by a threshold T3 is carried out. As the result of the determination, if the time indicated by the threshold T3 has already elapsed from the last background all-channel scan, the control flow proceeds to a step S507. At the step S507, the background all-channels scan is carried out.

As the result of the determination of the step S501, when the last background all-channel scan was carried out within the seconds indicated by the threshold T3 from now, the control flow proceeds to a step S502. At the step S502, the time of the non-communication is determined from the transmission/reception time of the VoIP frame in the upstream and downstream directions. Then, the non-communication time is selected, and switching to the channel used by the handover destination candidate is carried out.

At a step S503, values to be set as the Min-Channel-Time and the Max-Channel-Time are read from the verification scan parameter storage area and set for the respective registers. At a step S504, the Probe Request frame is transmitted. At a step S505, the determination is carried out of whether the Probe Response frame that is the response frame to the Probe Request frame is received from the access point of the handover destination candidate within a time designated by the Min-Channel-Time. As the result of the determination, if it is not received, the control flow proceeds to a step S506.

At the step S506, the determination of whether or not the Probe Response for the Probe Request has not been continuously received more than the number of times indicated by the threshold T2 is executed. As the result of the determination, the control flow returns to the step S504 in case of the number of times less than the number of times of reception indicated by the threshold T2, and the Probe Request frame is again transmitted. As the result of the determination, when the response is not yet generated more than the number of times indicated by the threshold T2, the VoIP terminal is regarded to be located outside the communicable area of the access point of the handover destination candidate. In this case, since the access point as another candidate needs to be newly searched, the control flow proceeds to a step S507. At the step S507, the background all-channels scan is carried out.

As the result of the process of the step S505, if the Probe Response frame is received from the access point of the handover destination candidate within a time designated by the Min-Channel-Time, the control flow proceeds to a step S508. At the step S508, the reception level of the Probe Response frame is checked.

At a step S509, the determination of whether or not the reception level is equal to or higher than the switching threshold is carried out. As the result of the determination, if the reception level is lower than the switching threshold, the VoIP terminal is not anymore located within the communicable area of the access point of the handover destination candidate. Therefore, the control flow proceeds to the step S507, and the background all-channels scan is carried out.

When the reception level is equal to or higher than the switching threshold, the access point as the current candidate of the handover destination has no problem as the candidate. As a result, the control flow proceeds to a step S510, and it is switched to the channel of the access point of the current candidate. In this case, the handover destination candidate needs not to be again selected by performing the all-channels scan. Therefore, at a step S511, values to be set for the Min-Channel-Time and the Max-Channel-Time are read from the usual scan parameter storage area and set for respective items. Then, the process of the verification scan is ended in an area in which the reception electric field intensity of the access point in the communication state at present is equal to or higher than the switching threshold.

### Third Exemplary Embodiment

The third exemplary embodiment of the present invention will be described below. In the second exemplary embodiment, at the step S509 in FIG. 10B, when the reception electric field intensity from the access point of the handover destination candidate is lower than the switching threshold, the background all-channels scan is carried out. In the third exemplary embodiment, the reception electric field intensity from the access point of the handover destination candidate that is obtained from the verification scan is left as a record. Then, at the step S509 in FIG. 10B, whether or not the reception electric field intensity obtained at this time is equal to or higher than the switching threshold is checked. Moreover, the change from the reception electric field intensity in a previous verification scan is also checked, and is also recorded. For example, the reception electric field intensity obtained in the previous verification scan is defined as a first reception electric field intensity S1, and the reception electric field intensity obtained by a current verification scan is defined as a second reception electric field intensity S2. When a next verification scan is carried out, the reception electric field intensity (estimation reception electric field intensity S3) can be predicted as follows.

Predicted Reception Electric Field Magnitude S3=Second Reception Electric Field Magnitude S2+(Second Reception Electric Field Magnitude S2−First Reception Electric Field Magnitude S1).

If the predicted reception electric field intensity S3 is lower than the switching threshold, the background all-channels scan is carried out even if the second reception electric field intensity S2 has a value higher than the switching threshold. It should be noted that in the third exemplary embodiment, only the result of the previous verification scan is used to predict the result of the next verification scan. However, it is possible to use a value in which the precision of a prediction value as the result of the next verification scan is improved by using not only the previous result but also a result before it.

As mentioned above, in the third exemplary embodiment, prior to carrying out the handover, whether or not the access point as the handover destination candidate is valid is checked in advance by carrying out the verification scan. Thus, it is possible to reduce influence on the speech/audio quality of a VoIP call when the VoIP terminal moves to a location outside the communicable area of the handover destination candidate.

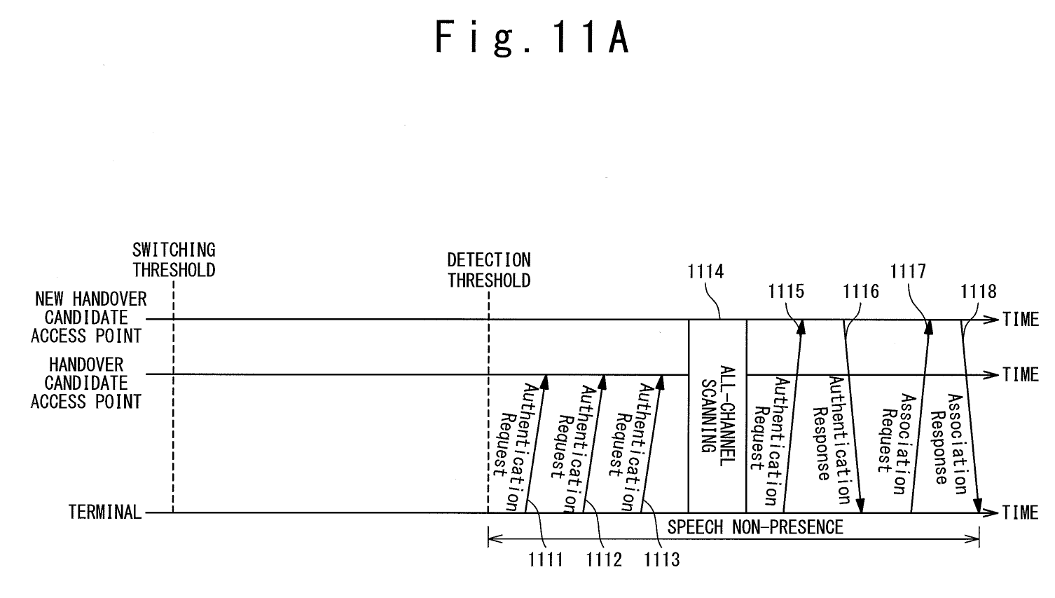

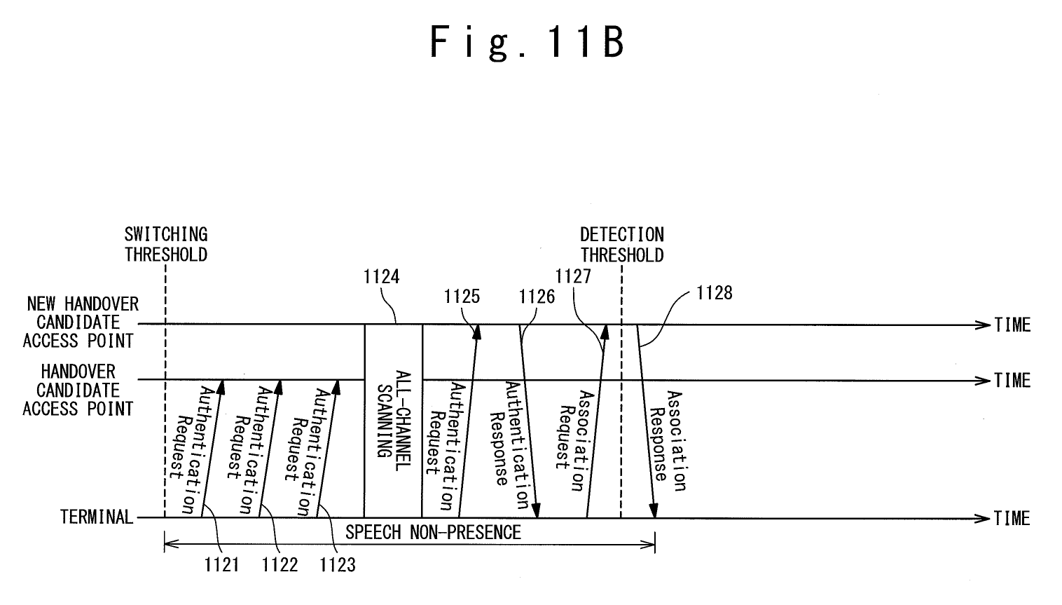

FIG. 11A and FIG. 11B are sequence diagrams showing operations when the verification scan in the above-mentioned exemplary embodiment is not carried out. FIG. 11A shows the operation when the verification scan is not carried out and then handover is carried out at the time that the reception electric field intensity of the access point in the communication state at present reaches a detection threshold. FIG. 11B is a sequence diagram showing the operation when the verification scan is not carried out and the handover is carried out at the time when the reception electric field intensity of the access point in the communication state at present reaches the switching threshold. The sequences of FIG. 11A and FIG. 11B show examples when the terminal is located outside the communicable area of the handover destination candidate.

With reference to FIG. 11A, when the reception electric field intensity of the access point in the communication state at present reaches a detection threshold, the terminal transmits an Authentication Request frame (1111, 1112 and 1113). The number of times of re-transmissions and the re-transmission interval of this Authentication Request frame depends on implementation. However, the Authentication Request frame is a frame for changing the management state of the terminal at the access point. In order to avoid the contradiction of the states between the access point and the terminal and surely exchange, the re-transmission of the comparatively large number of times is carried out.

FIG. 11A shows a case in which the re-transmission is carried out three times. Next, the all-channels scan is carried out (1114). After that, an Authentication Request/Response frame and an Association Request/Response frame are exchanged (1115, 1116, 1117 and 1118). In case of the operation shown in FIG. 11A, the handover is carried out after the reception electric field intensity of the access point in the communication state at present becomes lower than the detection threshold. For this reason, in a period from when the terminal transmits the first Authentication Request frame (1111) to when the Association Response is received (1118), the terminal cannot transmit/receive data. Thus, a disconnection occurs.

FIG. 11B shows the operation in which the handover is carried out when the reception electric field intensity of the access point in the communication state at present reaches the switching threshold. In this case, a start point is a time when the reception electric field intensity of the access point in the communication state at present reaches the switching threshold. It should be noted that the configuration except it is similar to the sequence of FIG. 11A. Also, in this case, in the period from when the terminal transmits the Authentication Request (1121) to when the Authentication Response frame is received (1128), the terminal cannot transmit/receive any data frame. Thus, the disconnection is caused in this period.

As mentioned above, in case that the verification scan is not carried out, the disconnection is caused for a longer time which is a summation of a time required to transmit and re-transmit the Authentication Request frame, a re-transmission time interval of the Authentication Request frame, and a time necessary for the all-channels scan, as compared with a case of performing the verification scan.

Tentatively, in the operation shown in FIG. 11B, it is supposed that the operations of the exchange of the Authentication Request/Response message and the all-channels scan can be carried out without any influence on transmission/reception of data of the terminal. The disconnected time in this case is only a period from when the Authentication Request is transmitted to the candidate of a new handover destination (1125) to when the Association Response is received (1128). Thus, the length of the disconnection is equal between a case of performing the verification scan and a case of not performing.

However, when the Authentication Request frame is re-transmitted many times (1122, 1123), there is a possibility that the terminal goes outside the communicable area with the access point in the communication state at present, and the disconnection occurs. In order to prevent this, when the switching threshold is set to a greater value, the area in which the reception electric field intensity equal to or more than the switching threshold is provided is made narrow, which results in the frequent occurrences of the handover. This is not preferable.

The configuration and operation of the above-mentioned exemplary embodiments are contained, and the verification scan is firstly carried out, which makes a period having a possibility of the occurrence of the disconnection to set the period from when the Authentication Request is transmitted (1104) to when the Association Response is received (1107).

In the above-mentioned exemplary embodiments, when the handover is predicted to be carried out, the verification scan in which the temporal and electric power costs are lower is carried out, and whether or not the terminal is located within the communicable area with the handover destination candidate. If the terminal is determined to be located outside the communicable area of the handover destination candidate, the data of the access point is collected by use of a usable channel between the communications, so as not to obstruct the communication with the access point in the communication state at present. Thus, a proper handover destination can be found out, to which the handover can be carried out. For example, it is possible to reduce the occurrence of the disconnection because the incommunicable access point is selected as the handover candidate, during the VoIP call.

Also, in the above-mentioned exemplary embodiments, by mixing the verification scan when the access point of the handover destination candidate is checked, it is possible to reduce a frequency of execution of the all-channels scan and a power consumption amount. Also, the check of the reasonability of the access point of the handover destination candidate can be executed more frequently. When the check of the reasonability is carried out more frequently, the access point of the handover destination candidate becomes more reasonable. Thus, for example, during the VoIP call, the probability of the failure of the handover is reduced, which can avoid the degradation in the speech/audio quality of the VoIP call at the time of the handover.

It should be noted that one skilled in the art can easily execute various variations of the above-mentioned exemplary embodiments. Thus, the present invention is not limited to the above-mentioned exemplary embodiments. This is construed in the widest range that can be considered in accordance with claims and its equivalents.

What is claimed is:

1-26. (canceled)

27. A wireless terminal comprising:
a data transmitting/receiving section configured to transmit and receive data in wireless; and
a handover control section configured to scan all of usable wireless channels to detect existence or non-existence of a handover destination,
wherein said handover control section acquires a handover destination candidate by scanning to detect the existence or non-existence of the handover destination in advance before execution of handover, predicts a period during which said data does not exist, in advance by using periodicity of said data, to check whether or not said handover destination candidate is in a communicable area with said terminal, carries out said verification scan in the predicted period during which it is predicted that said data does not exist, and carries out a handover to said handover destination candidate based on an execution result of said verification scan.

28. The wireless terminal according to claim 27, wherein said handover control section transmits a frame to check whether or not said handover destination candidate exists, and detects whether or not said handover destination candidate exists in a communicable area, based on the presence or non-presence of a response frame to the transmitted frame.

29. The wireless terminal according to claim 28, wherein as a condition to determine whether or not said handover destination candidate exists in the communicable area, said handover control section determines that said terminal is located in the communicable area of said handover destination candidate, when said response frame is not received from said handover destination candidate even if said verification scan is carried out more than the number of times designated by a threshold.

30. The wireless terminal according to claim 27, wherein said handover control section carries out said verification scan when a predetermined threshold time elapses from a time when said handover destination candidate is determined, as a start condition of said verification scan

31. The wireless terminal according to claim 27, wherein said handover control section uses reception electric field intensity of said data for determination of start of said verification scan.

32. The wireless terminal according to claim 31, wherein as a condition of the start of said verification scan, a threshold value is a value larger than a minimum value of the reception electric field intensity in a communicable state in said wireless LAN system, and the reception electric field intensity of an access point in a communication state with said terminal is less than said threshold value.

33. The wireless terminal according to claim 32, wherein said handover control section determines whether or not said handover destination candidate is in a communicable area after said verification scan, and scans all of usable wireless channels so as not to obstruct communication of said wireless LAN terminal and re-searches said handover destination candidate, when said reception electric field intensity of said response frame from said handover destination candidate is smaller than the threshold value which is larger than the minimum value of said reception electric field intensity.

34. The wireless terminal according to claim 32, wherein said handover control section carries out said verification scan when not meeting the start condition of said verification scan, and scans all of the usable wireless channels to find said handover destination candidate, when said terminal does not exist in a communicable area of said handover destination candidate which was found previously.

35. The wireless terminal according to claim 32, wherein said handover control section carries out said verification scan when not meeting the start condition of said verification scan, and scans all of the usable wireless channels to find said handover destination candidate, when said terminal is determined to go outside of a communicable area of said handover destination which was found previously.

36. A handover method in a wireless LAN system having a data transmitting/receiving function in which data is transmitted/received in wireless and a function to scan all usable wireless channels to detect existence or non-existence of a handover destination, said handover method comprising:
(a) acquiring a handover destination candidate by scanning to detect the existence or non-existence of a handover destination in advance before execution of a handover;
(b) carrying out a verification scan to check whether or not said handover destination candidate exists in a communicable area from said terminal; and
(c) carrying out a handover to said handover destination candidate based on an execution result of said verification scan,
wherein said (b) step comprises:
predicting a period during which said data does not exist, in advance by using periodicity of the data; and
carrying out said verification scan in the predicted period during which it is predicted that said data does not exist.

37. The handover method according to claim 36, wherein said (b) step comprises:
transmitting a frame to check whether or not said handover destination candidate exists;
waiting for reception of a response frame from said handover destination candidate; and
determining whether or not said handover destination candidate exists in a communicable area, based on the existence or non-existence of a response frame to the transmitted frame.

38. The handover method according to claim 37, wherein as a condition to determine whether or not said handover destination candidate exists in the communicable area, it is determined that said terminal is located in the communicable area of said handover destination candidate, when said response frame is not received from said handover destination candidate even if said verification scan is carried out more than the number of times designated by a threshold.

39. The handover method according to claim 36, wherein said (b) step comprises:
carrying out said verification scan when a predetermined threshold time elapses from a time when said handover destination candidate is determined, as a start condition of said verification scan.

40. The handover method according to claim 36, wherein reception electric field intensity of said data is used for determination of start of said verification scan.

41. The handover method according to claim 40, wherein as a condition of the start of said verification scan, a threshold value is a value larger than a minimum value of the reception electric field intensity in a communicable state in said wireless LAN system, and the reception electric field intensity of an access point in a communication state with said terminal is less than said threshold value.

42. The handover method according to claim 41, further comprising:
(d) determining whether or not said handover destination candidate after said verification scan is in a communicable area,
wherein said (d) step comprises:
scanning all of usable wireless channels so as not to obstruct communication of said wireless LAN terminal when said reception electric field intensity of said response frame from said handover destination candidate is smaller than the threshold value which is larger than the minimum value of said reception electric field intensity; and
re-searching said handover destination candidate.

43. The handover method according to claim 41, further comprising:
(e) finding out said handover destination candidate when not meeting the start condition of said verification scan,
wherein said (e) step comprises:
finding out said handover destination candidate by scanning all of the usable wireless channels, when said verification scan is carried out and said terminal does not exist in a communicable area of said handover destination candidate which was found previously.

44. The handover method according to claim 41, further comprising:
(f) finding out said handover destination candidate in case not to meet said verification scan start condition,
wherein said (f) step comprises:
finding out said handover destination candidate by scanning all of the usable wireless channels, when said verification scan is carried out and said terminal is determined to go outside of a communicable area of said handover destination which was found previously.

45. A wireless terminal comprising:
a data transmitting/receiving section configured to transmit and receive data in wireless; and
a handover control section configured to scan all of usable wireless channels to detect existence or non-existence of a handover destination,
wherein said handover control section acquires said handover destination candidate by performing the scanning to detect existence or non-existence of the handover destination in advance before handover execution, carries out verification scan to check whether or not the said handover destination candidate is in a communicable area with said terminal, uses a Probe Request frame and a Probe Response frame which are defined in IEEE 802.11 specification in said wireless terminal which carries out a handover to said handover destination candidate based on an execution result of said verification scan, and sets a minimum wait time from when said Probe Request frame is transmitted to when said Probe Response frame is received, and a wait time applied when one or more said Probe Response frames are received, to small values to an extent that transmission/reception of said data is not obstructed.

46. The wireless terminal according to claim 45, wherein said handover control section transmits said Probe Request frame as a frame to check whether or not said handover destination candidate exists, and determines whether or not said handover destination candidate is in the communicable area based on existence or non-existence of reception of said Probe Response frame which is a response frame to the transmitted frame.

47. The wireless terminal according to claim 45, wherein as a condition to determine whether or not said handover destination candidate is in the communicable area, said terminal determines to be out of a communicable area of said handover destination candidate when said response frame from said handover destination candidate is not received even if said verification scan is carried out more than the number of times designated by a threshold.

48. The wireless terminal according to claim 45, wherein said handover control section carries out said verification scan when a predetermined threshold time elapses from determination of said handover destination candidate, as said verification scan start condition.

49. The wireless terminal according to claim 45, wherein said handover control section uses reception electric field intensity of said data for the determination of start of said verification scan.

50. The wireless terminal according to claim 49, wherein said verification scan start condition is, a threshold value is a value larger than a minimum value of the reception electric field intensity with which it is possible to communicate in said wireless LAN system, and
the reception electric field intensity of the access point while said terminal is communicating is smaller than said threshold value.

51. The wireless terminal according to claim 50, wherein said handover control section determines whether or not said handover destination candidate after said verification scan is in the communicable area, and scans all usable wireless channels to re-searches said handover destination candidate when the reception electric field intensity when receiving said response frame from said handover destination candidate is smaller than the threshold value which is larger than the minimum value of the reception electric field intensity, so as not to obstruct the communication of said wireless LAN terminal.

52. The wireless terminal according to claim 50, wherein said handover control section carries out said verification scan when not meeting said verification scan start condition, and scans all usable wireless channels to find said handover destination candidate when it is determined that said terminal does not exist in the communicable area with said handover destination candidate found previously.

53. The wireless terminal according to claim 50, wherein said handover control section carries out said verification scan when not meeting said verification scan start condition, and scans all usable wireless channels to detect said handover destination candidate when it is determined that said terminal goes out of the communicable area with said handover destination candidate found previously.

54. A handover method in a wireless LAN system which comprises a data transmitting/receiving function of transmitting/receiving a data in wireless and a function to scan channels to detect existence or non-existence of a handover destination candidate over all usable wireless channels, said handover method comprising:
(a) acquiring said handover destination candidate by scanning the existence or non-existence of said handover destination candidate in advance before handover execution;
(b) carrying out a verification scan to check whether or not said handover destination candidate is in the communicable area with the terminal; and
(c) carrying out a handover to said handover destination candidate based on the execution result of said verification scan,
wherein a Probe Request frame and a Probe Response frame which are defined in IEEE 802.11 specification are used, and
a minimum wait time from when said Probe Request frame is transmitted to when said Probe Response frame is received and a wait time applied to when one or more said Probe Response frames are received are set to small values to an extent that the transmission/reception of the data is not obstructed.

55. The handover method according to claim 54, wherein said (b) step comprises:
transmitting said Probe Request frame as a frame to check whether or not said handover destination candidate exists;
waiting for reception of said Probe Response frame as a response frame from said handover destination candidate; and
checking whether or not said terminal is in the communicable area with said handover destination candidate based on the existence or non-existence of the reception of said response frame from said handover destination candidate.

56. The handover method according to claim 55, wherein as a condition to determine whether or not said terminal is in the communicable area with said handover destination candidate, said terminal determines that said terminal is in the communicable area with said handover destination candidate, when said response frame from said handover destination candidate is not received even if said verification scan is carried out more than the number of times of a threshold value.

57. The handover method according to claim 54, wherein said (b) step comprises:
carrying out said verification scan when a predetermined threshold time elapses from when said handover destination candidate is determined, as said verification scan start condition.

58. The handover method according to claim 54, wherein the reception electric field intensity of said data is used for determination of start of said verification scan.

59. The handover method according to claim 58, wherein said verification scan start condition is that a threshold value is larger than a minimum value of the reception electric field intensity with which it is possible to communicate in said wireless LAN system, and the reception electric field intensity of an access point with which said terminal is communicating is smaller than the threshold value.

60. The handover method according to claim 59, further comprising:
(d) determining whether or not said handover destination candidate after said verification scan is in the communicable area,
wherein said (d) step comprises:
scanning all usable wireless channels when the reception electric field intensity on reception of said response frame from said handover destination candidate is smaller than the threshold value which is larger than a minimum value of said reception electric field intensity, so as not to obstruct the communication of said wireless LAN terminal;
and re-searching said handover destination candidate.

61. The handover method according to claim 59, further comprising:
(e) finding said handover destination candidate when not meeting said verification scan start condition,
wherein said (e) step comprises:
scanning all usable wireless channels to find said handover destination candidate, when said verification scan is carried out and said terminal is not in the communicable area with said handover destination candidate found previously.

62. The handover method according to claim 59, further comprising:
(f) finding said handover destination candidate when not meeting said verification scan start condition,
wherein said (f) step comprises:
scanning all usable wireless channels to find said handover destination candidate, when said verification scan is carried out and it is determined that said terminal goes out of the communicable area with said handover destination candidate found previously.
